(19) United States
(12) Patent Application Publication
(10) Pub. No.: US 2026/0304134 A1
(43) Pub. Date: Oct. 1, 2026

(54) AVATAR AUTHENTICATION WITH 5G TRUST

(71) Applicant: Nokia Technologies Oy, Espoo (FI)

(72) Inventors: Saurabh KHARE, Bangalore (IN); German PEINADO GOMEZ, Wroclaw (PL); K TIRUMALESWAR REDDY, Bangalore (IN); Chaitanya AGGARWAL, Munich (DE); Ranganathan MAVUREDDI DHANASEKARAN, Munich (DE)

(21) Appl. No.: 19/489,849

(22) PCT Filed: Jul. 10, 2024
(86) PCT No.: PCT/IB2024/056737

§ 371 Date: Dec. 3, 2025

(30) Foreign Application Priority Data
Jul. 11, 2023 (IN) 202311046525

(51) Int. Cl. H04W 12/72; H04L 9/32; H04W 12/06; H04W 76/20

(52) U.S. Cl. CPC H04W 12/72; H04L 9/3247; H04W 12/06; H04W 76/20

(57) ABSTRACT

There is provided an apparatus comprising means for receiving, at an entity of a network from a user equipment, an indication of an identity associated with an avatar for use in an application function, wherein the user equipment is authenticated with the network and the application function has a trust relationship with the entity, determining, based on the identity associated with avatar, a digital signature and providing the digital signature to at least one of the user equipment and the application function for use in validating the avatar from the user equipment for use in the application function.

### FIELD

The present application relates to a method, apparatus, system and computer program and in particular but not exclusively to avatar authentication with 5G trust.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

In a first aspect there is provided an apparatus comprising means for receiving, at an entity of a network from a user equipment, an indication of an identity associated with an avatar for use in an application function, wherein the user equipment is authenticated with the network and the application function has a trust relationship with the entity, determining, based on the identity associated with avatar, a digital signature and providing the digital signature to at least one of the user equipment and the application function for use in validating the avatar from the user equipment for use in the application function.

The digital signature may comprise at least one of a hash of the identity associated with the avatar, the identity of the avatar, an identity associated with the user equipment and an expiry time period.

Determining the digital signature may comprise generating the digital signature.

The apparatus may comprise means for generating the digital signature using a digital certificate or a public and private key pair.

The apparatus may comprise means for providing the digital signature to the user equipment in a user equipment parameter provisioning procedure.

The application function may be a metaverse application function.

The apparatus may comprise means for receiving the indication of the identity via non-access stratum signalling or user plane signalling.

The indication of the identity associated with the avatar may comprise a hash of the identity.

The indication of the identity may comprise a binary file or other format file representing the avatar.

The apparatus may comprise means for generating a hash of the identity based on the binary file or other format file.

The entity of the network may comprise a core network function.

The network function may comprise a unified data management function or an authentication server function.

In a second aspect there is provided an apparatus comprising means for determining, at a user equipment, an indication of an identity associated with an avatar for use in an application function, providing an indication of the identity to an entity of a network, wherein the user equipment is authenticated with the network and receiving a digital signature, the digital signature determined at the network based on the identity associated with avatar and for use in validating the avatar from the user equipment for use in the application function.

The digital signature may comprise at least one of a hash of the identity associated with the avatar, the identity of the avatar, an identity associated with the user equipment and an expiry time period.

The apparatus may comprise means for receiving the digital signature at the user equipment in a user equipment parameter provisioning procedure.

The application function may be a metaverse application function.

The apparatus may comprise means for providing the indication of the identity to the entity of the network via non-access stratum signalling or user plane signalling.

The indication of the identity associated with the avatar may comprise a hash of the identity.

The indication of the identity may comprise a binary file or other format file representing the avatar.

The apparatus may comprise means for providing an indication of the avatar identity and the digital signature to the application function for use in validating the avatar from the user equipment at the application function.

In a third aspect there is provided an apparatus comprising means for receiving at an application function, from a user equipment or an entity of a network, an indication of an identity associated with an avatar for use in the application function and a digital signature determined by the entity, wherein the application function has a trust relationship with the entity of the network, validating the signature at the application function based on the trust relationship and using the avatar in the application function.

The digital signature may comprise at least one of a hash of the identity associated with the avatar, the identity of the avatar, an identity associated with the user equipment and an expiry time period.

The application function may be a metaverse application function.

In a fourth aspect there is provided a method comprising receiving, at an entity of a network from a user equipment, an indication of an identity associated with an avatar for use in an application function, wherein the user equipment is authenticated with the network and the application function has a trust relationship with the entity, determining, based on the identity associated with avatar, a digital signature and providing the digital signature to at least one of the user equipment and the application function for use in validating the avatar from the user equipment for use in the application function.

The digital signature may comprise at least one of a hash of the identity associated with the avatar, the identity of the avatar, an identity associated with the user equipment and an expiry time period.

Determining the digital signature may comprise generating the digital signature.

The method may comprise generating the digital signature using a digital certificate or a public and private key pair.

The method may comprise providing the digital signature to the user equipment in a user equipment parameter provisioning procedure.

The application function may be a metaverse application function.

The method may comprise receiving the indication of the identity via non-access stratum signalling or user plane signalling.

The indication of the identity associated with the avatar may comprise a hash of the identity.

The indication of the identity may comprise a binary file or other format file representing the avatar.

The method may comprise generating a hash of the identity based on the binary file or other format file.

The entity of the network may comprise a core network function.

The network function may comprise a unified data management function or an authentication server function.

In a fifth aspect there is provided a method comprising determining, at a user equipment, an indication of an identity associated with an avatar for use in an application function, providing an indication of the identity to an entity of a network, wherein the user equipment is authenticated with the network and receiving a digital signature, the digital signature determined at the network based on the identity associated with avatar and for use in validating the avatar from the user equipment for use in the application function.

The digital signature may comprise at least one of a hash of the identity associated with the avatar, the identity of the avatar, an identity associated with the user equipment and an expiry time period.

The method may comprise receiving the digital signature at the user equipment in a user equipment parameter provisioning procedure.

The application function may be a metaverse application function.

The method may comprise providing the indication of the identity to the entity of the network via non-access stratum signalling or user plane signalling.

The indication of the identity associated with the avatar may comprise a hash of the identity.

The indication of the identity may comprise a binary file or other format file representing the avatar.

The method may comprise providing an indication of the avatar identity and the digital signature to the application function for use in validating the avatar from the user equipment at the application function.

In a sixth aspect there is provided a method comprising receiving at an application function, from a user equipment or an entity of a network, an indication of an identity associated with an avatar for use in the application function and a digital signature determined by the entity, wherein the application function has a trust relationship with the entity of the network, validating the signature at the application function based on the trust relationship and using the avatar in the application function.

The digital signature may comprise at least one of a hash of the identity associated with the avatar, the identity of the avatar, an identity associated with the user equipment and an expiry time period.

The application function may be a metaverse application function.

In a seventh aspect there is provided an apparatus comprising at least one processor, and at least one memory including computer program code, wherein the at least one memory and the computer program code are configured, with the at least one processor, to cause the apparatus at least to receive, at an entity of a network from a user equipment, an indication of an identity associated with an avatar for use in an application function, wherein the user equipment is authenticated with the network and the application function has a trust relationship with the entity, determine, based on the identity associated with avatar, a digital signature and provide the digital signature to at least one of the user equipment and the application function for use in validating the avatar from the user equipment for use in the application function.

The digital signature may comprise at least one of a hash of the identity associated with the avatar, the identity of the avatar, an identity associated with the user equipment and an expiry time period.

Determining the digital signature may comprise generating the digital signature.

The apparatus may be caused to generate the digital signature using a digital certificate or a public and private key pair.

The apparatus may be caused to provide the digital signature to the user equipment in a user equipment parameter provisioning procedure.

The application function may be a metaverse application function.

The apparatus may be caused to receive the indication of the identity via non-access stratum signalling or user plane signalling.

The indication of the identity associated with the avatar may comprise a hash of the identity.

The indication of the identity may comprise a binary file or other format file representing the avatar.

The apparatus may be caused to generate a hash of the identity based on the binary file or other format file.

The entity of the network may comprise a core network function.

The network function may comprise a unified data management function or an authentication server function.

In an eighth aspect there is provided an apparatus comprising at least one processor, and at least one memory including computer program code, wherein the at least one memory and the computer program code are configured, with the at least one processor, to cause the apparatus at least to determine, at a user equipment, an indication of an identity associated with an avatar for use in an application function, provide an indication of the identity to an entity of a network, wherein the user equipment is authenticated with the network and receive a digital signature, the digital signature determined at the network based on the identity associated with avatar and for use in validating the avatar from the user equipment for use in the application function.

The digital signature may comprise at least one of a hash of the identity associated with the avatar, the identity of the avatar, an identity associated with the user equipment and an expiry time period.

The apparatus may be caused to receive the digital signature at the user equipment in a user equipment parameter provisioning procedure.

The application function may be a metaverse application function.

The apparatus may be caused to provide the indication of the identity to the entity of the network via non-access stratum signalling or user plane signalling.

The indication of the identity associated with the avatar may comprise a hash of the identity.

The indication of the identity may comprise a binary file or other format file representing the avatar.

The apparatus may be caused to provide an indication of the avatar identity and the digital signature to the application function for use in validating the avatar from the user equipment at the application function.

In a ninth aspect there is an apparatus comprising at least one processor, and at least one memory including computer program code, wherein the at least one memory and the computer program code are configured, with the at least one processor, to cause the apparatus at least to receive at an application function, from a user equipment or an entity of a network, an indication of an identity associated with an avatar for use in the application function and a digital signature determined by the entity, wherein the application function has a trust relationship with the entity of the network, validate the signature at the application function based on the trust relationship and use the avatar in the application function.

The digital signature may comprise at least one of a hash of the identity associated with the avatar, the identity of the avatar, an identity associated with the user equipment and an expiry time period.

The application function may be a metaverse application function.

In a tenth aspect there is provided a computer readable medium comprising instructions which, when executed by an apparatus, cause the apparatus to perform at least the following receiving, at an entity of a network from a user equipment, an indication of an identity associated with an avatar for use in an application function, wherein the user equipment is authenticated with the network and the application function has a trust relationship with the entity, determining, based on the identity associated with avatar, a digital signature and providing the digital signature to at least one of the user equipment and the application function for use in validating the avatar from the user equipment for use in the application function.

The digital signature may comprise at least one of a hash of the identity associated with the avatar, the identity of the avatar, an identity associated with the user equipment and an expiry time period.

Determining the digital signature may comprise generating the digital signature.

The apparatus may be caused to perform generating the digital signature using a digital certificate or a public and private key pair.

The apparatus may be caused to perform providing the digital signature to the user equipment in a user equipment parameter provisioning procedure.

The application function may be a metaverse application function.

The apparatus may be caused to perform receiving the indication of the identity via non-access stratum signalling or user plane signalling.

The indication of the identity associated with the avatar may comprise a hash of the identity.

The indication of the identity may comprise a binary file or other format file representing the avatar.

The apparatus may be caused to perform generating a hash of the identity based on the binary file or other format file.

The entity of the network may comprise a core network function.

The network function may comprise a unified data management function or an authentication server function.

In an eleventh aspect there is provided a computer readable medium comprising instructions which, when executed by an apparatus, cause the apparatus to perform at least the following: determining, at a user equipment, an indication of an identity associated with an avatar for use in an application function, providing an indication of the identity to an entity of a network, wherein the user equipment is authenticated with the network and receiving a digital signature, the digital signature determined at the network based on the identity associated with avatar and for use in validating the avatar from the user equipment for use in the application function.

The digital signature may comprise at least one of a hash of the identity associated with the avatar, the identity of the avatar, an identity associated with the user equipment and an expiry time period.

The apparatus may be caused to perform receiving the digital signature at the user equipment in a user equipment parameter provisioning procedure.

The application function may be a metaverse application function.

The apparatus may be caused to perform providing the indication of the identity to the entity of the network via non-access stratum signalling or user plane signalling.

The indication of the identity associated with the avatar may comprise a hash of the identity.

The indication of the identity may comprise a binary file or other format file representing the avatar.

The apparatus may be caused to perform providing an indication of the avatar identity and the digital signature to the application function for use in validating the avatar from the user equipment at the application function.

In a twelfth aspect there is provided a computer readable medium comprising instructions which, when executed by an apparatus, cause the apparatus to perform at least the following: receiving at an application function, from a user equipment or an entity of a network, an indication of an identity associated with an avatar for use in the application function and a digital signature determined by the entity, wherein the application function has a trust relationship with the entity of the network, validating the signature at the application function based on the trust relationship and using the avatar in the application function.

The digital signature may comprise at least one of a hash of the identity associated with the avatar, the identity of the avatar, an identity associated with the user equipment and an expiry time period.

The application function may be a metaverse application function.

In a thirteenth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a schematic diagram of an example user avatar;

FIG. 5 shows a schematic diagram of example user avatars in a metaverse environment;

FIG. 6 shows a flowchart of a method according to an example embodiment;

FIG. 7 shows a flowchart of a method according to an example embodiment;

FIG. 8 shows a flowchart of a method according to an example embodiment;

FIG. 9 shows a call flow according to an example embodiment.

### DETAILED DESCRIPTION

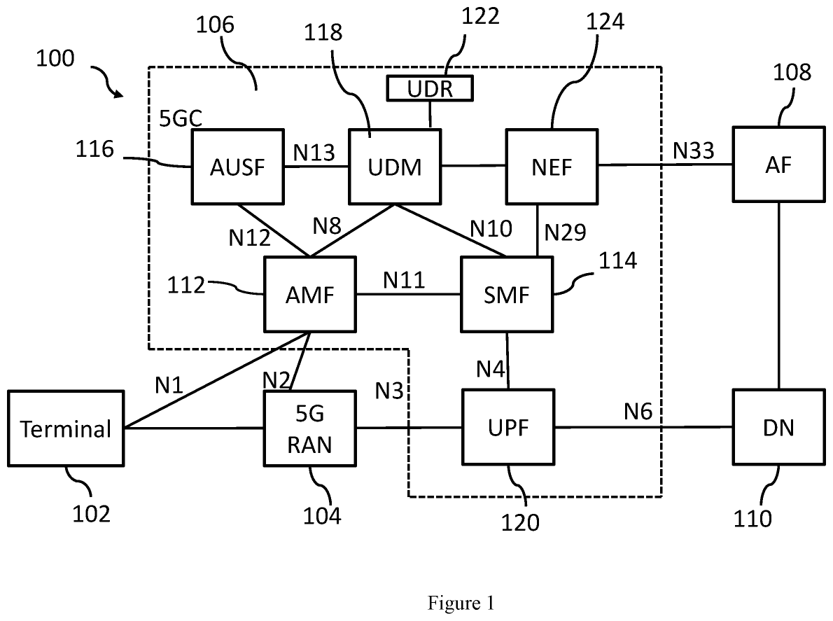

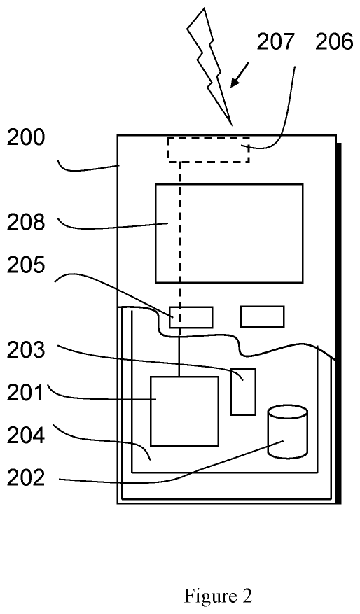

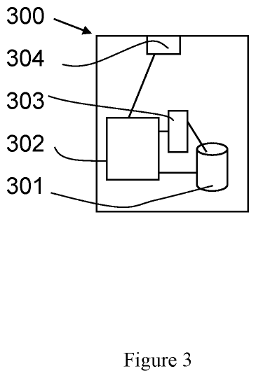

Before explaining in detail the examples, certain general principles of a wireless communication system and mobile communication devices are briefly explained with reference to FIG. 1, FIG. 2 and FIG. 3 to assist in understanding the technology underlying the described examples.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QoS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit (DU) functions connected to one or more gNodeB (gNB) Centralized Unit (CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant components can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or Serving Gateway (S-GW) or Packet Data Network Gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

In computing, the term “avatar” is used to describe a graphical representation of a user or user's character or persona. The term was used to describe a player's character in a number of games in the late 1970s into the late 1980s. In 1992, Neal Stephenson used the term to describe virtual simulation of the human form as well as the term “metaverse”.

Avatars are used in a number of ways today, besides their original use as digital representations of characters in video games. For example, avatars may serve as a digital representation of a user in Internet forums. These may be an animated version of a person's face or an image representing them.

The representation may be one to one (one user is represented by one digital representation) however users may be represented in multiple ways (especially over time). Groups of users may have an avatar to represent them or programs or automated services (i.e., not human users) may be represented with an avatar. Users may choose their own avatars and may change these frequently, even adopting the avatars of other users if there is no policy to prevent this or users may have avatars assigned to them.

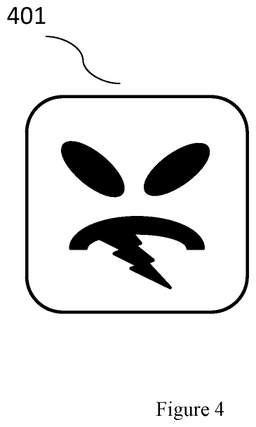

FIG. 4 shows an example of an avatar 401 for a community member on an Internet forum.

Avatars have been used to improve interaction between people using software or accessing on-line services and software. An example is “Clippy”, the paperclip ‘help feature’ in Microsoft Office 97.

There are many other such digital representations that are used, e.g., for on-line chat services or for service desks, etc.

A digital representation may be static (that is not animated or minimally animated (e.g., a.gif file)) and serve to provide a user with a unique personality in an on-line forum or service, but without divulging an actual appearance. This is a common use on social media platforms.

Alternatively, avatars may be animated, e.g. remote controlled. Avatar is a digital representation specific to media that encodes facial and/or body position, motions and/or expressions of a person or some software generated entity. An early example of this was SecondLife. [Linden Lab]. This platform does not feature a ‘game.’ Rather players interact, build things, share information, purchase virtual accoutrements. Some institutions built an on-line virtual presence, such as universities, private corporations even political parties to enable interaction between users represented as avatars. This is an early example of a “metaverse” environment.

Motion capture/animated avatars may be used to stand in for a person. They model and reproduce or mimic the user's movements, facial expressions and often represent specific facial animation for ‘talking’ in a way reminiscent of cartoons. One area where this has developed is a kind of content production by ‘vtuber’ contributors. Tools to create avatars (vtube animation software) can be coupled with motion capture software to allow contributors to generate video content in the form of animation. The creator is represented by media generated by means of a model and cameras. Sound can be added or recorded along with the video input.

A ‘live’ application may be designed around the techniques of animation and visual capture and provide an opportunity for users to communicate as cartoon digital representations of themselves with encoding and presentation in real-time. The communicating partner may be a human user or a ‘bot.’

A sophisticated ‘video capture,’ then transformation into avatar form with audio, and rendering this into media, is a computationally intense task. There are many tools to create avatars and vtube video clips, however these are generally not ‘live.’

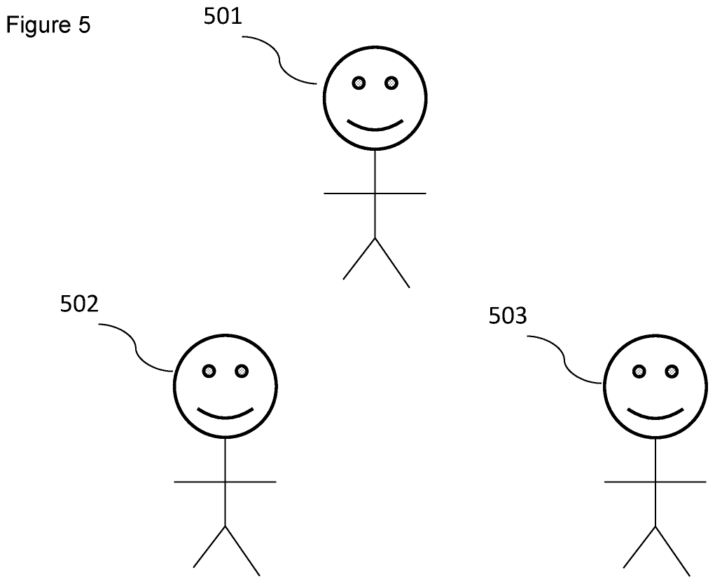

FIG. 5 shows an example group of avatars 501, 502 and 503 in discussion. Each avatar may have distinguishing features and does not necessarily appear as a human form.

A 5G system shall be able to authenticate and authorise an avatar to be used in mobile metaverse services. Once 5G/UE provides the avatar to metaverse (e.g., a metaverse application), the metaverse shall trust (guarantee) that the avatar belongs only to the authenticated and authorized user and binding of the user and avatar is trusted, i.e. avatar X is really belongs to user X. How to enable this trust has not been defined.

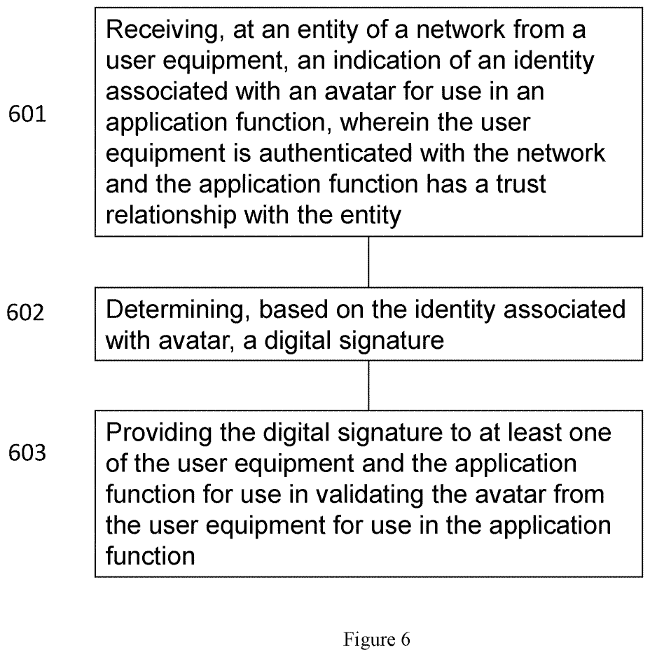

FIG. 6 shows a flowchart of a method according to an example embodiment. The method may be performed at an entity of a network (or “network entity”), e.g., an entity of a 5GCN such as, but not limited to, a UDM, AUSF or any other suitable existing or new NF in 5GC. The network function may be hosted on a server.

In 601, the method comprises receiving, at an entity of a network from a user equipment, an indication of an identity associated with an avatar for use in an application function, wherein the user equipment is authenticated with the network and the application function has a trust relationship with the entity.

In 602, the method comprises determining, based on the identity associated with avatar, a digital signature.

In 603, the method comprises providing the digital signature to at least one of the user equipment and the application function for use in validating the avatar from the user equipment for use in the application function.

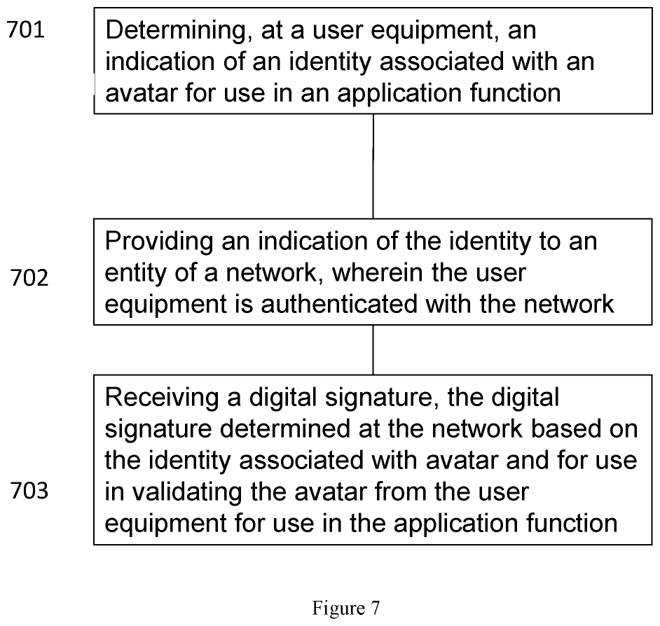

FIG. 7 shows a flowchart of a method according to an example embodiment. The method may be performed at a UE.

In 701, the method comprises determining, at a user equipment, an indication of an identity associated with an avatar for use in an application function.

In 702, the method comprises providing an indication of the identity to an entity of a network, wherein the user equipment is authenticated with the network.

In 703, the method comprises receiving a digital signature, the digital signature determined at the network based on the identity associated with avatar and for use in validating the avatar from the user equipment for use in the application function.

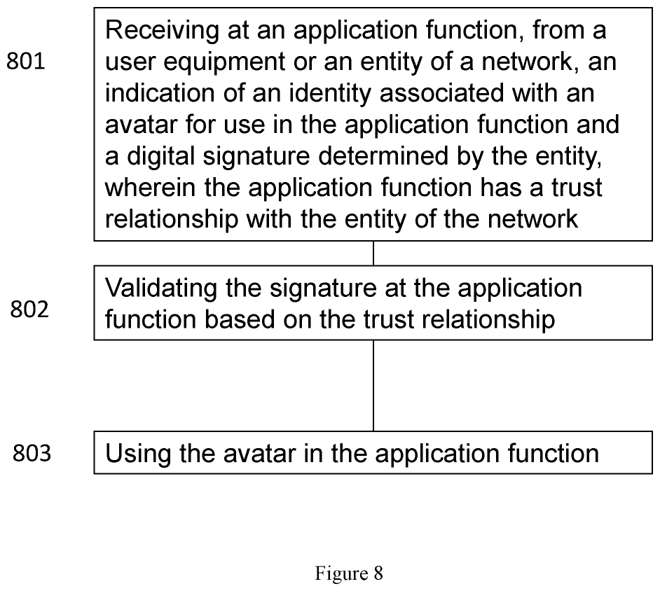

The application (AF) in the methods described with reference FIGS. 7 and 8 may be a metaverse AF (or “metaverse function”).

FIG. 8 shows a flowchart of a method according to an example embodiment. The method may be performed at an application function (AF), e.g., a metaverse application function. The AF may be hosted on a server.

In 801, the method comprises receiving at an application function, from a user equipment or an entity of a network, an indication of an identity associated with an avatar for use in the application function and a digital signature determined by the entity, wherein the application function has a trust relationship with the entity of the network.

In 802, the method comprises validating the signature based on the trust relationship.

In 803, the application comprises using the avatar in the application function.

Determining the digital signature at the entity of the network may comprise generating the digital signature. The digital signature may be generated using a digital certificate or a public and private key pair.

Where the digital signature is generated using a digital certificate, the AF may use Public Key Infrastructure (PKIX) validation to verify the certificate.

Where the digital signature is generated using a public and private key pair, the public key may be provisioned on the AF (for example by internal certificate authority (CA)).

The method may provide authentication and authorization of avatars based on 5G trust. For example, by determining a digital signature, an entity in a 5GC signs the avatar.

The digital signature may comprise at least one of a hash of the identity associated with the avatar, the identity of the avatar and an identity associated with the user equipment (e.g., GPSI, MSISDN number or any other suitable UE identifier). The at least one of a hash of the identity associated with the avatar, the identity of the avatar and an identity associated with the user equipment may be included as information elements (IEs) in the digital signature. An entity (e.g., metaverse AF) which can verify the signature can trust the avatar and associated properties e.g., hash of the avatar file, name, MSISDN, expiry of signature.

The digital signature may comprise an expiry time. The expiry time may be included as an IE in the digital signature. The expiry time may ensure the avatar can be used, e.g. in a metaverse, for a certain period according to the expiry time. In other words, a metaverse function may be authorized to use avatar for a limited period. After the expiry, metaverse may ask a UE to use the avatar again and the UE may initiate the authentication again.

A UE may provide the indication of the identity associated with the avatar to the entity of a network via non-access stratum signalling (e.g., CP packet) or user plane signalling (e.g., UP packet).

The identity associated with the avatar may be referred to as a digital identity. An application running on the UE may provide the digital identity to the UE. The application may provide a request to the UE to authenticate the avatar for use at the AF. The UE may then perform the method as described with reference to FIG. 7.

The indication of the identity associated with the avatar may comprise a hash of the identity. Alternatively, or in addition, an indication of the identity may comprise a binary file indicating the digital identity, or any other suitable format file representing the avatar. Where the indication of the identity comprises a binary or other format file, the network entity may generate a hash of the identity based on the binary or other format file.

The network entity may provide the digital signature and avatar identity to the user equipment, e.g., for provision to the AF. The UE may provide the indication of the avatar identity and the digital signature to the AF so that the AF can validate the avatar for use in the AF, based on the trust relationship with the network entity. In an example embodiment, if the AF determines that the avatar is valid, then it trusts the avatar and properties associated with the digital signature (name, expiry, etc. . . . ).

In one example embodiment, the network entity provides the digital signature to the UE in a in a UE parameter provisioning (UPU) procedure. For example, the network entity may provide the digital signature to the UE in a UPU container. The UPU procedure may ensure that the digital signature and avatar identity is integrity protected and cyphered by the network. In this way, only the UE can decrypt the digital signature and avatar identity, adding a further layer of security.

In an alternative embodiment, the network entity provides the indication of the avatar identity and the digital signature to the AF (e.g. metaverse function) so that the AF can validate the avatar for use in the AF, based on the trust relationship with the network entity. In an example embodiment, if the AF determines that the avatar is valid, then it trusts the avatar and properties associated with the digital signature (name, expiry, etc. . . . )

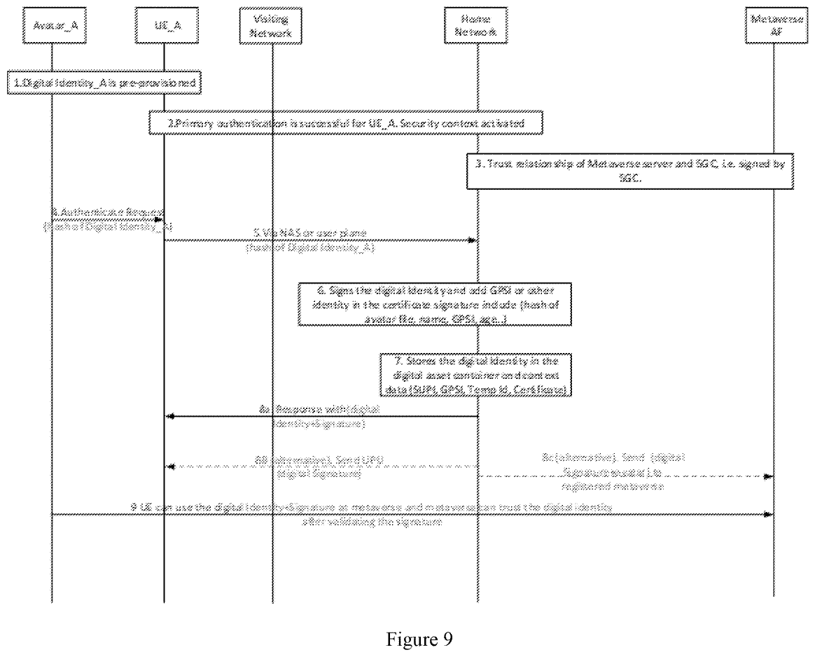

FIG. 9 shows a signalling diagram according to an example embodiment for a UE (UE_A), an avatar (Avatar_A). In the example embodiment shown in FIG. 9, the entity of the network is an entity of a Home Network. The AF is a metaverse AF.

In step 1, a digital identity associated with the avatar (referred to as Digital Identity_A) is provisioned in UE_A for Avatar_A. Similar provisioning for further avatars may happen in other UEs as well.

In step 2, the UE performs primary authentication with an entity of the Home Network. The 5GS primary authentication is successful for UE_A in a home network. Security context is activated after NAS and AS security mode command procedure.

In step 3, a trust relationship between the metaverse server and 5GC is established. In this way an identity coming from the 5GC (which, for example, includes a digitally signature) can be verified by the Metaverse server. The trust may be established using transport layer security (TSL) or any other suitable procedure for establishing trust.

In step 4, Avatar_A, or application of avatar_A, sends an Avatar authenticate request with a hash (e.g., SHA-256) of the Digital_identity_A (which comprises a binary file avatar.abc) to UE_A.

In step 5, since the UE has secured a connection with network, the hash of Digital_identity_A can sent to home network, either via NAS control plane (CP packet) or User plane message (UP packet). This step is an example of receiving, at an entity of a network from a user equipment, an indication of an identity associated with an avatar for use in an application function, wherein the user equipment is authenticated with the network and the application function has a trust relationship with the entity.

In step 6, the home network adds GPSI (or other UE identity) and other details/IE in the certificate signature. Other IEs may include the hash of avatar file, avatar name, GPSI, etc. The Home network may use a public/private key-pair or a PKI certificate for the signature generation. This step is an example of determining, based on the identity associated with avatar, a digital signature.

```
An example of a signature contains (
  Hash of avatar file avatar.abc
  Name of the avatar: ranga_cool
  GPSI: +91886233545
  Expiry: 2 days
)
```

In step 7, the Home network will store the digital identity and context data like SUPI, GPSI, Temp ID and signature in a digital asset container.

In step 8a, the home network responds to the UE with the digital identity and the signature. This is an example of providing the digital signature to the UE.

Alternatively, in step 8b, the Home network responds with success to UE and then sends separate UPU container comprising the signature of the avatar to confidentially protect the message, e.g., from the visiting network, VPLMN. This is an example of providing the digital signature to the UE in a UPU procedure.

Alternatively, as shown in step 8c, the Home network sends the avatar and signature to metaverse AFs directly. In this example embodiment, AFs are registered in 5GC and 5GC provides avatar and signature to all or selected metaverses. Expiry in the signature plays a role of authorization for a limited period. This is an example of providing the digital signature to the AF from the network entity.

In step 9, the UE uses the signed digital identity at Metaverse and Metaverse trusts the digital identity after validating the signature. This is an example of the AF validating the signature based on the trust relationship and using the avatar at the application function

Since trust is established by 5GC binding the avatar with an authenticated user identity, so metaverse can trust the avatar belongs to user.

An apparatus may comprise means for receiving, at an entity of a network from a user equipment, an indication of an identity associated with an avatar for use in an application function, wherein the user equipment is authenticated with the network and the application function has a trust relationship with the entity, determining, based on the identity associated with avatar, a digital signature and providing the digital signature to at least one of the user equipment and the application function for use in validating the avatar from the user equipment for use in the application function.

The apparatus may comprise the entity, such as a NF or a server hosting the NF, be the NF or be comprised in the NF or a chipset for performing at least some actions of/for the NF.

An apparatus may comprise means for determining, at a user equipment, an indication of an identity associated with an avatar for use in an application function, providing an indication of the identity to an entity of a network, wherein the user equipment is authenticated with the network and receiving a digital signature, the digital signature determined at the network based on the identity associated with avatar and for use in validating the avatar from the user equipment for use in the application function.

The apparatus may comprise the user equipment, such as a mobile phone, be the user equipment or be comprised in the user equipment or a chipset for performing at least some actions of/for the user equipment.

An apparatus may comprise means for receiving at an application function, from a user equipment or an entity of a network, an indication of an identity associated with an avatar for use in the application function and a digital signature determined by the entity, wherein the application function has a trust relationship with the entity of the network, validating the signature at the application function based on the trust relationship and using the avatar in the application function.

The apparatus may comprise the entity, such as an AF or a server hosting the AF, be the AF or be comprised in the AF or a chipset for performing at least some actions of/for the AF.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems such as 6G networks or 5G-Advanced networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions) and
I hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-32. (canceled)

33. A user equipment comprising at least one processor; and at least one memory storing instructions that, when executed by the at least one processor, cause the user equipment at least to perform:
determining an indication of an identity associated with an avatar for use in an application function;
providing the indication of the identity to an entity of a network, wherein the user equipment is authenticated with the network; and
receiving a digital signature for validating the avatar, wherein the digital signature is determined at the entity of the network based on the identity associated with the avatar.

34. The user equipment according to claim 33, wherein the digital signature comprises at least one of a hash of the identity associated with the avatar, the identity of the avatar, an identity associated with the user equipment or an expiry time period.

35. The user equipment according to claim 33, wherein the user equipment is further caused to perform receiving the digital signature in accordance with a procedure for provisioning user equipment parameters.

36. The user equipment according to claim 33, wherein the application function is a metaverse application function.

37. The user equipment according to claim 33, wherein the user equipment is further caused to perform providing the indication of the identity to the entity of the network via non-access stratum signalling or user plane signalling.

38. The user equipment according to claim 33, wherein the indication of the identity associated with the avatar comprises a hash of the identity.

39. The user equipment according to claim 33, wherein the indication of the identity comprises a binary file or other format file representing the avatar.

40. The user equipment according to claim 33, wherein the user equipment is further caused to perform providing an indication of the avatar identity and the digital signature to the application function for validating the avatar.

41. An apparatus for use in an entity of a network comprising: at least one processor;
and at least one memory storing instructions that, when executed by the at least one processor, cause the apparatus at least to perform:
receiving an indication of an identity associated with an avatar for use in an application function, wherein a user equipment is authenticated with the entity of the network and the application function has a trust relationship with the entity of the network;
determining, based on the identity associated with avatar, a digital signature; and
providing the digital signature to at least one of the user equipment or the application function for validating the avatar.

42. The apparatus according to claim 41, wherein the digital signature comprises at least one of a hash of the identity associated with the avatar, the identity of the avatar, an identity associated with the user equipment or an expiry time period.

43. The apparatus according to claim 41, wherein determining the digital signature comprises generating the digital signature.

44. The apparatus according to claim 43, wherein the apparatus is further caused to perform generating the digital signature using a digital certificate or a public and private key pair.

45. The apparatus according to claim 41, wherein the apparatus is further caused to perform providing the digital signature to the user equipment in a procedure for provisioning a user equipment parameters.

46. An apparatus for use in an application function comprising at least one processor;
and at least one memory storing instructions that, when executed by the at least one processor, cause the apparatus at least to perform:
receiving, from a user equipment or an entity of a network, an indication of an identity associated with an avatar for use in the application function and a digital signature for validating the avatar, wherein the digital signature is determined by the entity of the network, the application function has a trust relationship with the entity of the network;
validating the signature based on the trust relationship; and
using the avatar in the application function.

47. The apparatus according to claim 46, wherein the digital signature comprises at least one of a hash of the identity associated with the avatar, the identity of the avatar, an identity associated with the user equipment or an expiry time period.
